(19) United States
(12) Patent Application Publication
(10) Pub. No.: US 2002/0078401 A1
(43) Pub. Date: Jun. 20, 2002

(54) Test coverage analysis system

(76) Inventor: Michael Andrew Fry, Dallas, TX (US)

Correspondence Address: Daniel J. Chalker, Gardere Wynne Sewell L.L.P., 3000 Thanksgiving Tower, 1601 Elm Street, Dallas, TX, 75201-4761, US

(21) Appl. No.: 09/738,068

(22) Filed: Dec. 15, 2000

(51) Int. Cl. G06F 11/263

(52) U.S. Cl. 714/30

(57) ABSTRACT

The present invention provides a system, apparatus and method for determining a test coverage for a device by receiving test data from a test platform or development tool, processing the test data to determine or predict the test coverage for the device, and storing the test data and test coverage in a standard format. The test data includes the results of two or more tests on the device.

### FIELD OF THE INVENTION

The present invention relates generally to the field of test engineering and, more particularly, to a test coverage analysis system.

### BACKGROUND OF THE INVENTION

One of the more difficult tasks to perform in Test Engineering is to determine or predict the test coverage of a device under test (“DUT”) and unit under test (“UUT”) on an in-circuit test (“ICT”) platform or development tool. Currently, the process to extract the test data from the test platform or development tool and manipulate that data into a coverage report can take several days. Because this process is performed manually, there are also many opportunities for mistakes. Development tools that are now available do not have any built-in predicted coverage analysis tools. Also, the in-circuit testers' test analysis tools can make incorrect assumptions on coverage, resulting in inaccurate test coverage reports. Accordingly, there is a need to for a test coverage analysis system that overcomes these problems.

### SUMMARY OF THE INVENTION

The present invention automates the process of generating test coverage reports. By minimizing the human intervention, the present invention minimizes the time required to generate a test coverage report and minimizes the errors in the generated reports. This allows feedback to improve in-circuit test coverage to be obtained and utilized in a more efficient and timely manner.

More specifically, the present invention provides a method for determining a test coverage for a device by receiving test data from a test platform or development tool, processing the test data to determine or predict the test coverage for the device, and storing the test data and test coverage in a standard format. The test data includes the results of two or more tests on the device.

In addition, the present invention provides a method of measuring the actual and predicted results against each other to determine the accuracy of the predicted test coverage. This method uses the standard format test coverage data that was stored for the DUT.

The present invention also provides an apparatus for determining a test coverage for a device that includes an interface, a processor and a memory. The interface extracts test data from a test platform or development tool. The test data includes the two or more tests on the device. The processor is communicably linked to the interface and processes the test data to determine or predict the test coverage for the device. The memory is communicably linked to the processor and stores the test data and test coverage in a standard format.

In addition, the present invention provides a system for determining a test coverage for a device that includes a test platform or development tool, an interface, and a memory. The test platform or development tool generates test data, which includes the results of two or more tests on the device. The interface extracts test data from a test platform or development tool. The test data includes the two or more tests on the device. The processor is communicably linked to the interface and processes the test data to determine or predict the test coverage for the device. The memory is communicably linked to the processor and stores the test data and test coverage in a standard format.

The present invention also provides a computer program embodied on a computer readable medium for determining a test coverage for a device. The computer program includes a code segment for receiving test data from a test platform or development tool, a code segment for processing the test data to determine or predict the test coverage for the device, and a code segment for storing the test data and test coverage in a standard format. The test data includes results of two or more tests on the device.

Other features and advantages of the present invention will be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of a preferred embodiment of the present invention;

FIG. 2 is an illustration of a first embodiment of a standard format of the present invention; and

FIG. 3 is an illustration of a second embodiment of a standard format of the present invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the invention. The discussion herein relates to test engineering, specifically to automating the processing of test data to produce test coverage reports.

The present invention automates the process of generating test coverage reports. By minimizing the human intervention, the present invention minimizes the time required to generate a test coverage report and minimizes the errors in the generated reports. This allows feedback to improve in-circuit test coverage to be obtained and utilized in a more efficient and timely manner.

The present invention extracts test data from a test platform or development tool, such as Agilent 3173 or FabMaster, and processes that data into a standard presentation format. The processing may involve storing the raw test data in a computer readable structure such as a database. The standard presentation format can be, for example, a spreadsheet.

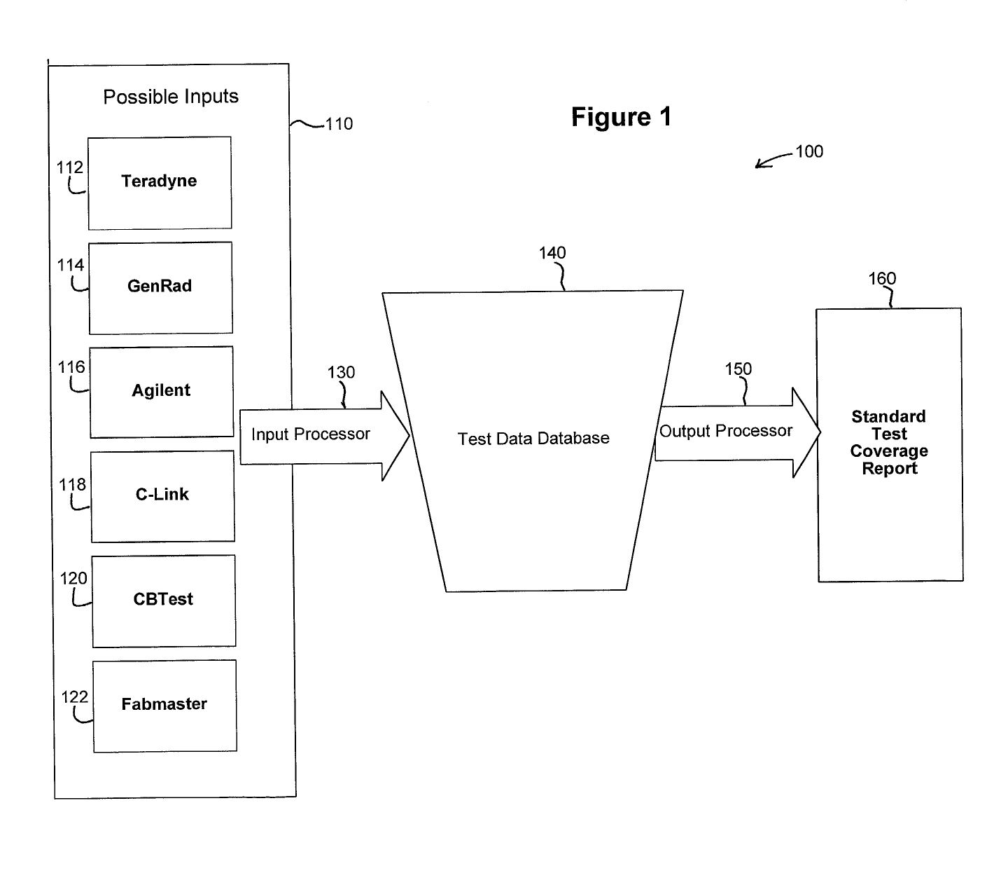

FIG. 1 is a block diagram of a preferred embodiment of the present invention 100. Platform 110 contains the test data. Possible inputs 112, 114, 116, 118, 120 and 122 indicate representative platforms from which test data can be obtained. These inputs 112, 114, 116, 118, 120 and 122 can be from in-circuit testers such as Agilent 116 or from development tools such as FabMaster 122 or from a platform not shown herein. Inputs 112, 114, 116, 118, 120 and 122 are intended solely as examples and should not be taken to limit the possible inputs to those shown in block 110, FIG. 1. Each type of platform 110 has a standard ASCII file or report that can be exported from its proprietary database. Input processor 130 exports the data from platform 110. This export can be accomplished by accessing the standard ASCII files or reports. Each platform 110 can require a customized input processor 130 in order to access the data. Input processor 130 then stores the exported test data in test data database 140. Test data database 140 can be made by any database tool or platform. Alternative computer readable storage structures, such as spreadsheets and text files, can be used instead of a database. Output processor 150 exports the data from the storage structure, test data database 140, into a standard presentation format, such as a standard test coverage report 160. Alternative standard presentation formats, such as spreadsheets and text files, can be used.

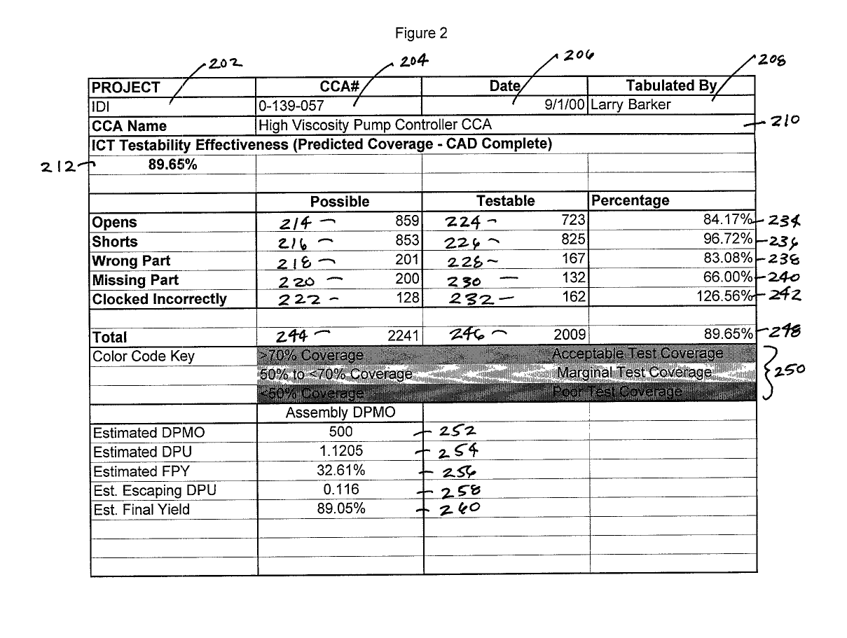

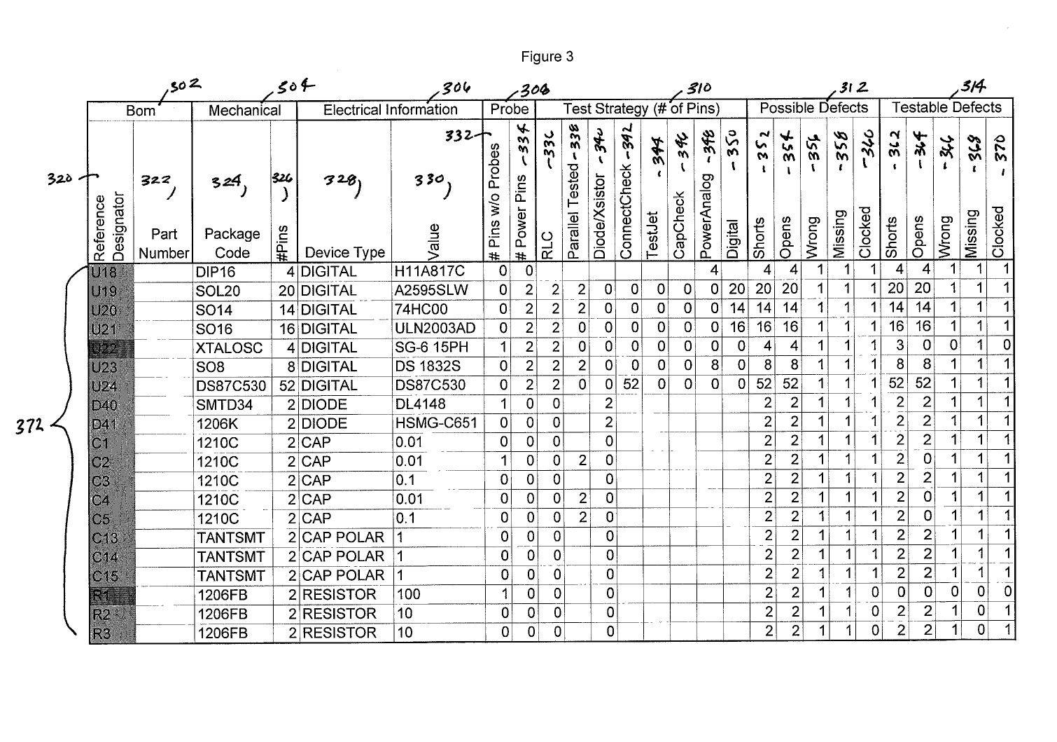

FIGS. 2 and 3 illustrate embodiments of a standard format of the present invention. Both are displayed in spreadsheet format although either may be presented in an alternative form, such as a text file. FIG. 2 illustrates a sample summary test coverage report that displays the results of calculations performed on the detailed data. FIG. 3 illustrates a sample detailed test coverage report that lists each part tested and specific test data for each. Color coding can also be integrated into the standard presentation format to draw immediate attention to areas that do not attain an acceptable rating.

More specifically, FIG. 2 includes the project name 202, CCA# 204, Date 206, Test Engineer Name 208, CCA Name 210 and ICT Testability Effectiveness (Predicted Coverage—CAD Complete) 212. The possible opens 214, possible shorts 216, possible wrong parts 218, possible missing parts 220, possible clocked incorrectly 222, and total possible 244 for the tested device are listed. The testable opens 224, testable shorts 226, testable wrong parts 228, testable missing parts 230, testable clocked incorrectly 232, and total testable 246 for the tested device are listed. The percentage opens 234, percentage shorts 236, percentage wrong parts 238, percentage missing parts 240, percentage clocked incorrectly 242, and total percentage 248 for the tested device are listed. A color code key 250 is provided to show that greater that 70% test coverage is acceptable, between 50% and 70% test coverage is marginal and less than 50% test coverage is poor. The Estimated DPMO 252, Estimated DPU 254, Estimated FPY 256, Estimated Escaping DPU 258 and Estimated Final Yield 260 for the Assembly DPMO is also provided.

FIG. 3 provides Bill of Material (“BOM”) information 302, mechanical information 304, electrical information 306, probe information 308, test strategy (# of pins) 310, possible defects 312 and testable defects 314 for the device. The Bom information 302 includes the reference designator 320 and part number 322 for the device. The mechanical information 304 includes the package code 324 and the number of pins 326 for the device. The electrical information 306 includes the device type 328 and the device value 330. The probe information 308 includes the number of pins without probes 332 and the number of power pins 334. The test strategy (# of pins) 310 includes RLC 336, parallel tested 338, diode/transistor 340, connection check 342, test jet 344, capacitor check 346, power (analog) 348 and power (digital) 350. The possible defects 312 includes shorts 352, opens 354, wrong part 356, missing part 358 and clocked incorrectly 360. The testable defects 314 includes shorts 362, opens 364, wrong part 366, missing part 368 and clocked incorrectly 370. Each of the rows 372 contain the data for a device.

Although preferred embodiments of the present invention have been described in detail, it will be understood by those skilled in the art that various modifications can be made therein without departing from the spirit and scope of the invention as set forth in the appended claims.

What is claimed is:

1. A method for determining a test coverage for a device, the method comprising the steps of:
receiving test data from a test platform or development tool, the test data comprising results of two or more tests on the device;
processing the test data to determine or predict the test coverage for the device; and
storing the test data and test coverage in a standard format.

2. The method as recited in claim 1, further comprising the step of determining the accuracy of the predicted test coverage for the device by comparing the actual and predicted test data.

3. The method as recited in claim 1 wherein the test data comprises a computer readable structure.

4. The method as recited in claim 1 wherein the standard format comprises a database.

5. The method as recited in claim 1 wherein the standard format comprises a file.

6. The method as recited in claim 1 wherein the standard format comprises a report.

7. The method as recited in claim 1 wherein the standard format comprises a spreadsheet.

8. The method as recited in claim 1, further comprising the step of performing two or more tests on the device using the test platform or development tool.

9. The method as recited in claim 1, further comprising the step of exporting the test data and test coverage in the standard format to a database.

10. An apparatus for determining a test coverage for a device comprising:
an interface for extracting test data from a test platform or development tool, the test data comprising results of two or more tests on the device; and
a processor communicably linked to the interface for processing the test data to determine or predict the test coverage for the device; and
a memory communicably linked to the processor for storing the test data and test coverage in a standard format.

11. The apparatus as recited in claim 10, wherein the processor also determines the accuracy of the predicted test coverage for the device by comparing the actual and predicted test data.

12. The apparatus as recited in claim 10 wherein the test data comprises a computer readable structure.

13. The apparatus as recited in claim 10 wherein the standard format comprises a database.

14. The apparatus as recited in claim 10 wherein the standard format comprises a file.

15. The apparatus as recited in claim 10 wherein the standard format comprises a report.

16. The apparatus as recited in claim 10 wherein the standard format comprises a spreadsheet.

17. A system for determining a test coverage for a device comprising:
a test platform or development tool that generates test data, which comprises results of two or more tests on the device;
an interface communicably linked to the test platform or development tool for extracting the test data;
a processor communicably linked to the interface for processing the test data to determine or predict the test coverage for the device; and
a memory communicably linked to the processor for storing the test data and test coverage in a standard format.

18. The system as recited in claim 17, wherein the processor also determines the accuracy of the predicted test coverage for the device by comparing the actual and predicted test data.

19. The system as recited in claim 17 wherein the test data comprises a computer readable structure.

20. The system as recited in claim 17 wherein the memory comprises a computer readable structure.

21. The system as recited in claim 17 wherein the standard format comprises a database.

22. The system as recited in claim 15 wherein the standard format comprises a file.

23. The system as recited in claim 17 wherein the standard format comprises a report.

24. The system as recited in claim 17 wherein the standard format comprises a spreadsheet.

25. A computer program embodied on a computer readable medium for determining a test coverage for a device comprising:
a code segment for receiving test data from a test platform or development tool, the test data comprising results of two or more tests on the device;
a code segment for processing the test data to determine or predict the test coverage for the device; and
a code segment for storing the test data and test coverage in a standard format.

26. The computer program as recited in claim 25, further comprising a code segment for determining the accuracy of the predicted test coverage for the device by comparing the actual and predicted test data.

27. The computer program as recited in claim 25 wherein the test data comprises a computer readable structure.

28. The computer program as recited in claim 25 wherein the storage structure comprises a computer readable structure.

29. The computer program as recited in claim 25 wherein the standard format comprises a database.

30. The computer program as recited in claim 25 wherein the standard format comprises a file.

31. The computer program as recited in claim 25 wherein the standard format comprises a report.

32. The computer program as recited in claim 25 wherein the standard format comprises a spreadsheet.

33. The computer program as recited in claim 25, further comprising a code segment for exporting the test data and test coverage in the standard format to a database.
